(19) United States
(12) Patent Application Publication
(10) Pub. No.: US 2017/0336193 A1
(43) Pub. Date: Nov. 23, 2017

(54) Method For Simultaneously Measuring Magnetic And Gravitational Fields Using Atom Interferometers

(71) Applicant: Francesco Narducci, Dowell, MD (US)

(72) Inventor: Francesco Narducci, Dowell, MD (US)

(73) Assignee: United States of America as represented by the Secretary of the Navy, Patuxent River, MD (US)

(21) Appl. No.: 15/158,251

(22) Filed: May 18, 2016

(51) Int. Cl. G01B 9/02; G21K 1/00

(52) U.S. Cl. CPC G01B 9/02001; G21K 1/006

(57) ABSTRACT

The present invention is a method for simultaneously measuring magnetic/magnetic gradient and gravitational fields using atom interferometers includes the steps of releasing laser cooled atoms from a trap, further cooling the released atoms, launching the atoms vertically, preparing the atoms into well-known atomic states, measuring gravity from the atoms as the atoms travel upward, and measuring the magnetic field of the atoms the begin to fall.

### STATEMENT OF GOVERNMENT INTEREST

The invention described herein may be manufactured and used by or for the Government of the United States of America for governmental purposes without payment of any royalties thereon or therefor.

### BACKGROUND

An atom interferometer is an interferometer based on exploiting the wave character of atoms. Atom interferometers are often used to make high-precision measurements of forces, such as those due to acceleration or rotation or magnetic fields.

### SUMMARY

The present invention is directed to a system with the needs enumerated above and below.

The present invention is directed to a method for simultaneously measuring magnetic and gravitational fields using atom interferometers that includes the steps of releasing laser cooled atoms from a trap, further cooling the released atoms, launching the atoms vertically, preparing the atoms into well-known atomic states, measuring gravity from the atoms as the atoms travel upward, and measuring the magnetic field of the atoms when they begin to fall.

The present invention provides a methodology to measure, nearly simultaneously, gravitational acceleration and magnetic fields/magnetic field gradients using an atom interferometer.

It is also a feature of the present invention to provide a methodology for the rapid changing of Raman frequencies.

It is a feature of the present invention to provide a method to enable high precision measurements of gravitational acceleration and magnetic fields/magnetic field gradients nearly simultaneously.

It is a feature of the present invention to provide a method that can be used for, but not limited to, underground tunnel detection, submarine and mine detection, oil exploration and inertial navigation.

### DESCRIPTION

The preferred embodiments of the present invention are illustrated by way of example below. The method for simultaneously measuring magnetic and gravitational fields using atom interferometers includes the steps of releasing laser cooled atoms from a trap, further cooling the released atoms, launching the atoms vertically, preparing the atoms into well-known atomic states, measuring gravity from the atoms as the atoms travel upward, and measuring the magnetic field of the atoms when the atoms begin to fall.

In the description of the present invention, the invention will be discussed in a laboratory environment; however, this invention can be utilized for any type of application that requires the measurement of magnetic and gravitational fields.

In the preferred embodiment of the invention, atoms are laser cooled to temperatures below 1 milliKelvin. Laser cooling of atoms involves, but without limitation, shining laser light at atoms from six directions with appropriate frequency of light and an appropriate tailored magnetic field. The combination of laser light and magnetic field creates a trap for the atoms. The laser light includes a cooling frequency and a repumper frequency. The frequency of the cooling laser is tuned slightly less than the frequency of the cycling transition of the atom. The frequency of the repumper is tuned to depopulate the unwanted ground state. The preferred embodiment utilizes rubidium atoms, but any atom amendable to laser cooling, such as, but without limitation, sodium, lithium, potassium, cesium, etc., can be used. The cooling of atoms is typically done in an ultra-high vacuum system (better than 10⁻⁸ torr).

The atoms are released from the trap by turning off the magnetic field, then further cooled. The released atoms can be further cooled by changing the laser cooling frequency. The released twice cooled atoms are then tossed up vertically in the vacuum system. The atoms may be tossed by changing the frequency of one of the vertical cooling beams by a small amount and the frequency of the other vertical cooling beam by the same amount in the other direction, creating an upward force on the atoms.

Atom interferometry may be performed to measure the gravity from the atoms as they travel upward and measure the magnetic field when the atoms begin to fall. Atom interferometry is performed on the atoms as they move upward in such a way as to extract a measurement of gravitational acceleration. Atom interferometry is then performed on the atoms as they fall back down in such as a way as to extract a measure of magnetic field and/or magnetic field gradients. It is also possible to measure magnetic fields and/or magnetic fields gradients first. Atom interferometry consists of the application of two or more Raman pulses of light. A measurement of gravitational acceleration and magnetic field gradients require a minimum of three Raman pulses, whereas the measurement of magnetic fields can be accomplished with two. A Raman pulse includes two laser frequencies, each of which is tuned far off resonance, but whose frequency difference coincides with the frequency difference of the ground states of the atom. The application of these laser pulses results in an interference pattern when the number of atoms in the upper ground state or lower ground state is measured. The phase of the interference pattern depends on gravitational acceleration, magnetic fields or magnetic fields gradients.

To perform the atom interferometry to measure gravitational acceleration, the Raman pulse is tuned to drive the magnetically insensitive Raman transition. To perform the atom interferometry to measure magnetic field or magnetic field gradients, the Raman pulse is tuned to drive any of the magnetically sensitive Raman transitions. To measure magnetic fields, two Raman pulses are applied and to measure magnetic field gradients, three pulses are applied. The measurement of gravitational acceleration on the way up and magnetic fields on the way down (or vice versa) requires rapid switching of the Raman frequency at the top of the atoms trajectory. This is accomplished using a digital signal synthesizer driving a high frequency acousto-optic modulator, from which the Raman frequencies are derived.

When introducing elements of the present invention or the preferred embodiment(s) thereof, the articles “a,” “an,” “the,” and “said” arc intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

1. A method for simultaneously measuring magnetic and gravitational fields using atom interferometers, the method comprising:
releasing laser cooled atoms from a trap;
further cooling the released atoms;
launching the atoms vertically;
using an atom interferometer, measuring gravity from the atoms as the atoms travel upward and measuring the magnetic field experienced by the atoms when the begin to fall.
